(19) United States
(12) Patent Application Publication
(10) Pub. No.: US 2021/0358049 A1
(43) Pub. Date: Nov. 18, 2021

(54) METHOD AND SYSTEM FOR COMPUTING A PHICHI SCORE, FOUR CATEGORY SCORES, A 4SCORE, AND A FINAL COMPOSITE THREAT (FCT) SCORE FOR A PROPERTY

(71) Applicant: Tammy Nichols Schwartz, Lakewood, CA (US)

(72) Inventor: Tammy Nichols Schwartz, Lakewood, CA (US)

(21) Appl. No.: 17/316,780

(22) Filed: May 11, 2021

Related U.S. Application Data
(60) Provisional application No. 63/020,085, filed on May 5, 2020.

(51) Int. Cl. G06Q 40/08; G06F 17/18; G06N 20/00; A62C 3/02

(52) U.S. Cl. CPC G06Q 40/08; A62C 3/02; G06N 20/00; G06F 17/18

(57) ABSTRACT

A method for computing a PhiChi score, four category scores, 4score and a Fire Composite Threat (FCT) score for a property comprises providing a fire composite score computation system comprising a processor, a memory unit, a fire composite score model, a graphical user interface (GUI), and a network interface card. A fire composite score reference table is stored within the memory unit comprising a first and a second set of variables. The first set of variables are derived from geospatial artificial intelligence (GEOAI) and wildfire data available in public databases. The second set of variables are derived from user feedback. Individual variable scores for the variables in the first and second set, the PhiChi score, the 4score comprising a Fuel score, an Ignitions score, a Susceptibility score and a Hazards score, and the FCT score are computed using the fire composite score model and the fire composite score reference table.

### CROSS-REFERENCE TO RELATED APPLICATIONS

This application claims priority to and the benefit of the provisional patent application No. 63/020,085, titled “Black Swan's Fire Composite score, known as the PhiChi Score, Assesses Wildfire Risk for Insurance Companies, Fire Protection Agencies, Government Entities, and the Public”, filed in the United States Patent and Trademark Office on May 5, 2020. The specification of the above referenced patent application is incorporated herein by reference in its entirety.

### BACKGROUND

The method and system disclosed herein, in general, relates to wildfire risk management, actuarial science and property and casualty insurance industry. More specifically, the method and system disclosed herein relates to using actuarial science for pricing wildfire risk by computing a fire composite score. The model produces a baseline fire composite score which captures the wildfire risk for a given location without consideration of wildfire protection, susceptibilities in the built environment, or consumer mitigation efforts. The baseline fire composite score referred to herein as the PhiChi score is abbreviated throughout the remainder of this document as “φχ”, where the Greek letters Phi (φ) and Chi (χ) represent the letters ‘F’ and ‘C’, respectively. Subsequent to the determination of the “φχ”, a user interface collects additional information including, but not limited to, defensible space, access to fire department equipment, neighborhood conflagration hazards, and hardening efforts which improve resilience. The complete fire composite score combines this additional information with the “φχ” data elements and summarizes the results in four subtotals, or Category Scores, referred to collectively as the 4score. The 4score is comprised of a Fuel score, an Ignition Sources score, a Susceptibility score, and a Hazards score. The “φχ” and the 4score are derived directly from Black Swan's wildfire risk model and corresponding reference table referred to herein as the fire composite score model and the fire composite score reference table, respectively. A Final composite threat (FCT) score is also computed for the property.

The patent application contemplates a summation of category scores to compute the complete fire composite score and alternative complex mathematical formulae to calculate the final composite threat (FCT) score. Advanced actuarial ratemaking methods can be applied to the individual category scores that comprise the 4score with non-uniform weights for each category, and a nonlinear relational portrayal of wildfire risk can be represented by a complex mathematical formula to obtain an actuarially sound estimate of expected loss propensity. The categories, for example, comprise Fuel, Ignitions, Susceptibilities, and Hazards. However, such an exercise is beyond the scope of this application. An abbreviated example is included for illustrative purposes only as it is not the intent of this application to patent any mathematical formulae or actuarial methods; but rather to provide new statistics which can be used in wildfire ratemaking and other actuarial applications; namely, the Category scores for Fuel, Ignitions, Susceptibilities, and Hazards.

Insured wildfire losses are soaring across the globe. Withdrawal of the property insurance market is driven almost entirely by the reinsurance market which is no longer willing to write wildfire-exposed properties. The capacity restriction has forced carriers to place moratoriums on new business in or near wildfire-prone areas and begin depopulating policies through a process known as a “Non-Renewal”. As capacity shrinks in the voluntary market, tens of thousands of property owners are referred to Fair Access to Insurance Requirements (FAIR) plan, where the coverage is sub-standard and costly.

Unfortunately, many of the policies referred to the FAIR plan have better-than-average wildfire risk. They may have an unacceptable wildfire score, or they may be in a “high risk area”, according to their insurance company, and still have very little wildfire exposure, or none. Conversely, there are also examples of homes exposed to wildfire on all sides and their wildfire score identifies them as being low risk or having no risk at all. Frankly, the models have not done a fair job of assigning relative risk levels to individual properties based on that property's actual exposure to loss. Fuel is the single most used statistic in wildfire risk assessments, followed by slope, access, and aspect as a distant fourth. For much of the industry, those are the only components. Regardless of the number of variables included, the output is one numerical value which may or may not be translated into a grade: A, B, C, D, F. There are no models designed to provide insight for property owners, or risk managers.

Based on the priorities established by the Western Fire Chiefs Association (WFCA) at the WFCA Wildfire Summit in Action Plan Recommendation for WFCA Wildland Fire Policy Committee, there exists a disconnect between public policy Wildland Urban Interface (WUI) mitigations and insurance industry risk assessment. What continues to connect successful public policy and successful implementation of risk mitigations is public behavior. Until public policy and insurance practices in the Wildland Urban Interface (WUI) are aligned, the desired public behavior of mitigation implementation and maintenance will not be consistently realized.”

By reducing risk levels, property owners can make their property more acceptable to preferred carriers who compete on price. The lack of transparency in the insurance industry is not unlike the challenges in the financial industry before the advent of the Fair Credit Reporting Act to give consumers insight and ultimately control over their Fair Isaac Corporation (FICO) scores. There was a time when people did not understand what drove their credit risk score. They did not know how to control it and it was a tremendous source of frustration, so much that it became the impetus for companies like mycredit.com and several other websites designed to educate and inform the consumer to improve their own credit worthiness. Similarly, wildfire models today are black boxes. Consumers are completely in the dark as to what may be causing their increase in premiums, or their difficulty in finding affordable coverage. They cannot ask their broker or agent or even an underwriter from the insurance company because they do not know how the models work either. Modelling companies like to keep that secret as proprietary information.

Not only is the industry in need of more transparency in wildfire modelling, but it is also critical that accuracy be improved. It is not enough to use slope without also considering the aspect, the location of the structure relative to that slope, the amount of setback, and defensible space. It is not enough to know the amount of fuel; it is also important to know the type of fuel, the rate of spread (ROS) or expected flame height, the likelihood of a wind-driven event, and the return period or fire regime group. There are dozens more variables that need to be included in the wildfire model and the present invention does exactly that; and more.

Furthermore, it is not enough to use more data. It is important how the information is conveyed so that consumers find the information actionable. Property owners must be in control of their own fate. In a wildfire event, firefighters are not dispatched so much for the protection of property as they are to control the spread of flames. There simply are not enough fire fighters or equipment to protect every structure. Therefore, the focus for landowners must be on surviving wildfire instead of planning on suppressing or avoiding it. Residents need to be able to take shelter in their homes keeping roads free for firefighting equipment. An effort in this direction starts with computing a comprehensive wildfire score for a property that includes everything that fire department engineers consider when inspecting for wildfire readiness, and everything determined by actuaries to be correlated with wildfire damage or loss. The complete modelling effort will be fully transparent. Property owners and risk managers will be able to review the factors that went into the wildfire risk score and dispute resolution processes will be in place if they determine any of the information to be inaccurate. Moreover, they will be able to determine how their risk levels might change if mitigation efforts are undertaken. The computed wildfire score will be accurate. Only when important predictive variables are missing, will the model be inaccurate and ineffective. There will be homogeneity in the groups of variables created by the model. As an effective model, it will create groups of homogeneous risks that perform similarly to each other, and differently compared to other groups.

Pricing models are used to group properties with similar risk characteristics together to form “homogeneous” groups so that actuaries may more accurately determine rate levels for each group. Rates are required by departments of insurance across the country to be “actuarially sound” which means they must be an accurate estimate of all expected future costs; they must be adequate to pay all future claims without being excessive; and they must not be unfairly discriminatory. In practice, this means actuaries set rates so that the loss performance of every group will be the same on average. This only works if property owners with the most risk pay the highest premiums and conversely, the lowest risk properties are associated with lowest premiums.

Standard market carriers try not to accept properties with the highest risk levels with each carrier having their own individual risk tolerance. The most widely used models today place 85%-90% of all properties in the lowest risk categories. Approximately 10-15% of homes are “moderate” while the remaining 5-10% at the tail end of the distribution are labelled as “high risk” or “extreme”. There are many models and, in every instance, too many policies are categorized as low risk. This is evidenced shortly after a major wildfire as insurance carriers find they have total losses on homes their models previously identified as “little or no risk”. Models are recalibrated, premiums shuffled, and policies passed from one carrier to another only to find, after the next wildfire event, that they again have “low risk” policies that have been destroyed by wildfire.

The industry's most popular model, Fireline© by Verisk® was used to score over 20,000 locations for an anonymous managing general agent (MGA). Model results were graphed along with expected average annual loss expressed as a percentage of total insured value. Each location's expected average annual loss was determined by a wildfire simulation model commonly used for reinsurance purchasing. As shown in FIG. 13A, approximately 90% of the locations tested had Fireline scores of 2 or less. The model scores range from 0 to 30. The expected average annual loss is sporadic on scores of 4 or higher and, consequently, most of the admitted property insurance market considers Fireline scores of 4 or more ineligible for “Underwriting reasons”.

Since different variables exist in every model, the adjustment at each recalibration results in the identification of different groups for each carrier and the renewal cycle begins to resemble a swap meet where one carrier's trash is another carrier's treasure, and the identified “high risk” policies are swapped from one carrier to another who sees them as “low risk”. Prevalent in every model available today, are heterogeneous groups of properties with identical scores despite varied risk levels and properties with different scores despite identical risk characteristics. Consequently, it comes as no surprise that loss performance may vary widely between policies within the same group. The fact that the models still rely on different variables strongly suggests that the current models are incomplete. Assuming all modelers have done significant work to tie these variables to loss performance, it stands to reason that the model which includes an exhaustive list of predictive variables would be preferential to any individual carrier's model which uses only a subset of those, assuming individual independent distributions. This hypothesis becomes theory in the section titled, “Summary of the Invention.”

Exacerbating the issue for carriers, having too many policies in the low category means there are not enough in the moderate and high categories. This introduces negative bias in the expected average loss for higher risk properties meaning the true average is higher than the empirical results might suggest. Not having enough policies in a category also increases the standard deviation, thereby requiring more data to achieve full credibility. From an actuarial perspective, this means the rates are essentially “watered down” when data is too sparse in a category and the effect of the price differentiation created by the model is muted. This prevents carriers from being able to accurately assign the highest premiums to policies with the highest risk, forcing low risk policies to bear more than their fair share of premiums. FIG. 13B illustrates a graph showing goodness of fit test for Fireline. As shown in FIG. 13B, the coefficient of determination, R², between the two model outputs is less than 66%.

Hence, there is a long felt but unresolved need for a method and a system for computing a complete fire composite score for a property using a comprehensive set of variables that use a combination of a first set of variables derived through geospatial artificial intelligence (GEOAI) and/or data stored in a public database, and a second set of variables that are derived from input data received from the users via an online questionnaire. The complete fire composite score computed in this manner is the 4score. Furthermore, there is a need for a method and a system that provides the PhiChi score and the 4score comprised of the Fuel score, the Ignitions score, the Susceptibility score and the Hazards score. Furthermore, there is a need for a method and a system that provides the final composite threat (FCT) score. Moreover, there is a need for a method and system that accurately groups properties together that have the same PhiChi score and same ratio between each of the four category scores. In the future, when sufficient data exists for full actuarial credibility standards, actuarial methods may be applied to the Category Scores to determine the Final Composite Threat curve which minimizes the sum of the squared deviations to provide the most actuarially sound estimate of expected loss per policy, based solely on 4score model output.

### SUMMARY OF THE INVENTION

This summary is provided to introduce a selection of concepts in a simplified form that are further disclosed in the detailed description of the invention. This summary is not intended to determine the scope of the claimed subject matter.

The method and system disclosed herein computes a complete fire composite score for a property using a comprehensive set of variables that use a combination of a first set of variables derived from wildfire data available through geospatial artificial intelligence (GEOAI) and/or stored in a public database, and a second set of variables that are derived from input data received from the users via an online questionnaire. The fire composite score computed in this manner is the 4score. The method and system disclosed herein provides the PhiChi score, 4score, and four individual category scores: the Fuel score, the Ignitions score, the Susceptibility score, and the Hazards score. As used herein, the 4score is a comprehensive wildfire risk assessment that provides information enabling a property owner to determine whether there is wildfire risk on the property, and how that risk may be mitigated. The method and system disclosed herein accurately groups properties together that have the same PhiChi score and same ratio between each of the four category scores that comprise the 4score. The method and system disclosed herein also computes the final composite threat (FCT) score of the property. Consider the following example where two locations are both scored as having 4score of 200. One of the locations has a score of 100 for Fuel and 100 for Hazards while the other location has a score of 50 for every category. The location with score of 50 in every category potentially has greater risk of loss than the one with a fuel score of 100 since it is completely protected with zero susceptibility and zero ignition sources.

The method and system disclosed herein aims to end the lack of transparency in wildfire pricing models, educate the public, and give property owners the ability to manage their own wildfire risk in the way that makes the most cents, and facilitates the development of actuarial methods to determine the Final Composite Threat curve for estimating future loss propensity based on 4score model output.

The method and system disclosed herein includes an automated self-assessment consistent with National Fire Protection Agency standards. The assessment identifies mitigation and maintenance plans to comply with 2018 Standard 1144: Reducing Structure Ignition Hazards from Wildland Fire. Publicly available data and geospatial artificial intelligence (GEOAI) are applied to identify the most prominent and dangerous fuel types on a parcel, including the surrounding area and the percentage of vegetation coverage relative to the built environment. Each property is then scored according to the fire composite score model that considers these and dozens of other factors affecting wildfire loss. The baseline fire composite score computed using the new model is called the PhiChi score.

FIG. 14A illustrates a graph showing distribution of policies by PhiChi score along with the expected average annual loss for risks in each category of Fuel, Ignitions, Susceptibilities, and Hazards. The same sample used to examine the average annual loss by the Fireline score, illustrated in FIG. 13A, was also tested against the new model. The distribution of scores by φχ was more favourable when compared to the Fireline as locations were more evenly distributed, approximating a Chi-Squared distribution which may converge to a Normal distribution with enough locations. The φχ was designed to replace the Fireline in both underwriting and pricing of wildfire risk. This was an important test in determining its potential efficacy.

FIG. 14B illustrates the PhiChi score's coefficient of determination for the same locations as in FIG. 14A, using the 5^{th} degree polynomial fit shown below, is 94.8%. This is a marked improvement over the legacy wildfire risk score provider(s).

A separate 4score model is designed to be used to inform the property owner through easy-to-understand risk categories and individual category scores for Fuel, Ignition Sources, Susceptibilities, and Hazards. With the 4score model, consumers are never left in the dark. Every data element used in the quantification of risk is provided to the users. It is not a black box leaving property owners powerless or without understanding of their true exposure to loss or damage caused by wildfire. The fire composite score model reveals all the underlying data to the users with full transparency providing a dispute resolution process to ensure the data is accurate. This also gives the property owners insight into ways to reduce their wildfire exposure and keep their insurance costs down; something the other models do not offer. The fire composite score model does more than create homogeneous groupings. It goes one step further to differentiate properties with same PhiChi (φχ) score by evaluating risk in a different way. The φχ score ranges from 0 to 280. In addition to the PhiChi score, four Category Scores, each ranging from 0 to 100, comprise the 4score: a Fuel score, an Ignition score, a Susceptibility score, and a Hazards score. The ratio of each category scores to the fire composite score is utilized to differentiate properties with the same PhiChi score but different risk profiles. The fire composite score ranges from 0 to 400. Only those with same ratio between each of the categories and the PhiChi score are grouped together and expected to perform similarly. This additional layer of information gives the carrier ultimate control over pricing, underwriting, and resulting loss ratios. This is good for consumers as more carriers in the market means more price competition and more coverage availability.

At the heart of the fire composite score model is a set of fifty comprehensive and qualitative variables that are categorized into four different categories, namely a Fuel category, an Ignitions category, a Susceptibility category, and a Hazards category.

Disclosed herein is a method and a system for computing a PhiChi score, a 4score, a final composite threat (FCT) score, and four category scores comprising a fuel score, an ignitions score, a susceptibility score, and a hazards score, for any property, using a comprehensive set of variables that uses a combination of a first set of variables derived from geospatial artificial intelligence, or GEOAI, and Big Data available from various data amalgamators, and a second set of variables that are derived from input received from the users through a self-assessment tool. Currently, geospatial artificial intelligence (GEOAI) is not used for deriving the second set of variables. In the future, it is contemplated that even when the second set of variables is derived from geospatial artificial intelligence (GEOAI), users should still be given the option to review and adjust the information as needed. The users comprise, for example, property owners, brokers, underwriters, fire department personnel, insurance department personnel, and municipality personnel. Also disclosed is a method and a system that provides both a fire composite score for pricing at the point of sale, and separate but related scores for underwriting purposes and renewal pricing incentives. Furthermore, disclosed is a method and system that accurately groups properties together that have the same PhiChi score, 4score, and same ratio between each of the four category scores. Moreover, the Category Scores provide a new set of statistics for actuaries to perform multivariate regression analysis to determine the best curve for predicting future loss propensity based on the four outputs.

The method comprises providing a fire composite score computation system comprising a processor, a memory unit coupled to the processor, a fire composite score model within the memory unit, a graphical user interface, and a network interface card for communicating with one or more users over a network. The method further comprises providing a fire composite score reference table comprising a first set of variables of the fire composite score model derived from geospatial artificial intelligence (GEOAI) and Big Data and a second set of variables of the fire composite score model derived from other sources including user input, self-inspection tools, and/or geospatial artificial intelligence (GEOAI). The first set of variables are automatically populated by the system from Big Data, except Fuel. Geospatial artificial intelligence (GEOAI) identifies the predominant Fuel type as the type of fuel in the immediate or surrounding area with the greatest propensity to burn and the percentage of vegetation is calculated as the ratio of area with vegetation relative to the total area including roads and structures. The area including roads and structures is referred to as the built environment. The method further comprises receiving input data from users via an interactive question and answer session using the graphical user interface. The questions are associated with the second set of variables. The method further comprises determining a score for each of the variables in the first set and each of the second set's variables using the fire composite score reference table. The method further comprises computing the PhiChi score of the property based on the scores of the first set of variables. The method further comprises incorporating the second set of variables and combining the individual variable scores into four category scores comprising a Fuel score, an Ignition score, a Susceptibility score, and a Hazards score. The method further comprises computing the 4score of the property by summation of the four category scores, and a Final Composite Threat (FCT) score may be ultimately determined through a nonlinear multivariate expression including all four category scores which may or may not have equal weights. Concepts of actuarial science relate historical data to model output using complex mathematical formulae for the purpose of identifying the maximum number of homogeneous classes of risk, each with a distinct and unique loss propensity and high degrees of actuarial credibility for ratemaking.

These customized algorithms are specific to the business written according to each program's specific class plan, rate plan, and underwriting restrictions. The algorithms, as unique as fingerprints, give companies a competitive advantage over those who have less access to sophisticated data elements such as the Final Composite Threat (FCT) score, the PhiChi, the 4score, or any of the four Category Scores. The PhiChi score of the property is transformed, by incorporating the second set of variables, into the 4score which can be transformed through actuarial applications into a uniquely accurate and comprehensive assessment of the wildfire risk of the property relative to other risks in the portfolio. Consider the following Table-1 with hypothetical data set of 25 locations, each with 4score of 120.

| [1] | [2] | [3] | [4] | [5] | [6] | [7] | [8] | [9] = [8] × [7] |
|---|---|---|---|---|---|---|---|---|
| ID | Fuel | Ignitions | Susceptibility | Hazards | FCT | Frequency | Severity | Pure Prem |
| 1 | 50 | 10 | 10 | 50 | 2000 | 0.40% | 200000 | 800 |
| 2 | 10 | 50 | 50 | 10 | 2000 | 0.40% | 200000 | 800 |
| 3 | 50 | 20 | 10 | 40 | 2700 | 0.54% | 270000 | 1458 |
| 4 | 40 | 10 | 20 | 50 | 2700 | 0.54% | 270000 | 1458 |
| 5 | 20 | 50 | 40 | 10 | 2700 | 0.54% | 270000 | 1458 |
| 6 | 10 | 40 | 50 | 20 | 2700 | 0.54% | 270000 | 1458 |
| 7 | 50 | 30 | 10 | 30 | 3200 | 0.64% | 320000 | 2048 |
| 8 | 40 | 20 | 20 | 40 | 3200 | 0.64% | 320000 | 2048 |
| 9 | 30 | 10 | 30 | 50 | 3200 | 0.64% | 320000 | 2048 |
| 10 | 30 | 50 | 30 | 10 | 3200 | 0.64% | 320000 | 2048 |
| 11 | 20 | 40 | 40 | 20 | 3200 | 0.64% | 320000 | 2048 |
| 12 | 10 | 30 | 50 | 30 | 3200 | 0.64% | 320000 | 2048 |
| 13 | 50 | 40 | 10 | 20 | 3500 | 0.70% | 350000 | 2450 |
| 14 | 40 | 30 | 20 | 30 | 3500 | 0.70% | 350000 | 2450 |
| 15 | 30 | 20 | 30 | 40 | 3500 | 0.70% | 350000 | 2450 |
| 16 | 20 | 10 | 40 | 50 | 3500 | 0.70% | 350000 | 2450 |
| 17 | 40 | 50 | 20 | 10 | 3500 | 0.70% | 350000 | 2450 |
| 18 | 30 | 40 | 30 | 20 | 3500 | 0.70% | 350000 | 2450 |
| 19 | 20 | 30 | 40 | 30 | 3500 | 0.70% | 350000 | 2450 |
| 20 | 10 | 20 | 50 | 40 | 3500 | 0.70% | 350000 | 2450 |
| 21 | 50 | 50 | 10 | 10 | 3600 | 0.72% | 360000 | 2592 |
| 22 | 40 | 40 | 20 | 20 | 3600 | 0.72% | 360000 | 2592 |
| 23 | 30 | 30 | 30 | 30 | 3600 | 0.72% | 360000 | 2592 |
| 24 | 20 | 20 | 40 | 40 | 3600 | 0.72% | 360000 | 2592 |
| 25 | 10 | 10 | 50 | 50 | 3600 | 0.72% | 360000 | 2592 |
| Avg | 30 | 30 | 30 | 30 | 3200 | 0.64% | 320000 | 2091 |

The 25 locations are included in the study with no locations having a score greater than 50 in any one category. As relatively low risk properties, they would likely all be acceptable from an underwriting perspective. Would the actuary charge them all the same rate since all 25 records have the same 4score? That will depend on the degree of influence each data point has on the overall risk score. Actuarial analyses will be needed to determine which categories are most predictive and that may vary by location. With an average frequency (# of claims per policy) of 0.64% and severity (average size of loss per claim) of $320,000, the average loss per policy in this hypothetical example is $2091, (0.64%×320,000=$2091), calculated as the product of frequency and severity. This value is known as the Pure Premium. A reasonable first approach to develop a customized algorithm using actuarial standards of practice would be to group the categories into frequency and severity components and multiply them together. In this case, Fuel and Hazards are severity drivers while Ignition sources and Susceptibilities are frequency drivers. In column [6] of the Table-1 above, we add the frequency components (Ignition sources+Susceptibilities) and multiply by the sum of the severity components (Fuel score+Hazards score) to compute the Final Composite Threat (FCT) score. FIG. 14C illustrates a resultant comparison chart that shows that the Final Composite Threat (FCT) score increases as the Pure Premium increases for the example shown, and, therefore, provides a better fit than the 4score alternative. As shown in FIG. 14C, FC-0 represents the 4score result based on the sum of each of the category scores. FC-3 represents the hypothetical Final Composite Threat (FCT) score illustrated in Table-1 above, in column [6].

The fire composite score computation system for computing a PhiChi score, a 4score, a Final Composite Threat (FCT) score, and four category scores comprised of a Fuel score, an Ignitions score, a Susceptibility score, and a Hazards score, for a given property, comprises the processor, the memory unit coupled to the processor, the fire composite score model within the memory unit, the graphical user interface, and the network interface card for communicating with one or more users over a network. A fire composite score reference table is stored within the memory unit. The fire composite score reference table comprises a first set of variables of the baseline fire composite score model derived from geospatial artificial intelligence (GEOAI) and Big Data to compute the PhiChi score, and a second set of variables of the fire composite score model derived from user input, self-inspection tools, and/or geospatial artificial intelligence (GEOAI). The first and the second set of variables are used to compute the complete fire composite score (4score), the final composite threat (FCT) score, and four category scores comprised of a Fuel score, Ignitions score, Susceptibility score, and a Hazards score.

The model may be completely automated without requiring user input using geospatial artificial intelligence (GEOAI) for deriving the variables in the second set. GEOAI already exists to determine the number of access roads using mapping capabilities and satellite imagery. It can also be used to determine whether the road is paved, and whether it is sufficiently wide for fire department equipment access. GEOAI is used to identify cul-de-sacs, dead-end roads, waterways, and freeways. It can similarly be used to identify bridges. GEOAI can also use geocoding to identify which homes lie along the periphery of a neighborhood in the WUI and can distinguish them from homes located deep within the community where wildfire risk is negligible. Complex terrain and topographical maps combined with satellite imagery can identify locations near adjacent steep slopes, difficult terrain, proximity to natural chimneys, and/or steep, narrow draws or ravines. Combined with the location's elevation, this information can determine the position of the structure relative to the highest and lowest elevations of the surrounding terrain. Structures which are closer to the top are at higher risk since flames spread upward faster than they spread downward. GEOAI can measure the amount of defensible space surrounding a structure and it can also monitor that space to provide alerts to property owners or insurers if/when re-growth impinges on the requisite defensible space.

GEOAI combined with area maps and satellite imagery can measure distance to nearby recreation areas, concert facilities, off-highway vehicle areas, campgrounds, picnic sites, mills or factories, railroad crossings, freeways and other high-traffic routes, powerlines in the immediate area, and presence of fencing attached directly to structure. Artificial intelligence applied to photos submitted by inspectors or property owners can determine presence of open construction features which increase risk of conflagration, such as unenclosed decks, balconies, or stairs. However, the ability to collect information directly from the customer may always be most relevant since satellite imagery is dated and views can be obstructed. Even when all the requisite information can be obtained instantaneously with Big Data and Artificial Intelligence, a graphical user interface will always be an important component for dispute resolution and mitigation planning. The automated score is just the starting point. The 4score has the potential to be forward-looking and thus provides the industry's first wildfire risk management tool. When risk levels are too high for risk-averse individuals or insurers, mitigation strategies can be identified using the model to optimize the Cost-Benefit equation and reduce wildfire risk in the most cost-effective way.

The processor is configured to receive input data via an interactive question and answer session using the graphical user interface or through an automated platform where completed inspections are maintained, and/or through geospatial artificial intelligence (GEOAI). The questions are associated with the second set of variables. The processor is further configured to determine the PhiChi score from the first set of variables and the 4score, by combining the PhiChi score with scores for each of the second set of variables using the fire composite score reference table. The processor is further configured to combine the individual variable scores into the four category scores comprising the Fuel score, the Ignitions score, the Susceptibilities score, and the Hazards score. The process may be further refined through actuarial methods to compute the Final Composite Threat (FCT) score of the property by applying complex mathematical formula to the four category scores. The Final Composite Threat (FCT) score for a property is computed by applying actuarial methods to the fire composite score model output based solely on the values assigned to each of 48 variables in the fire composite score reference table.

### BRIEF DESCRIPTION OF DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1 exemplarily illustrates a method for computing a PhiChi score, a 4score, a Final Composite Threat (FCT) score, and four category scores comprising a Fuel score, an Ignitions score, a Susceptibilities score, and a Hazards score for a property.

FIG. 2 exemplarily illustrates a fire composite score computation system for computing a PhiChi score, a 4score, a Final Composite Threat (FCT) score, and four category scores comprising a Fuel score, an Ignitions score, a Susceptibilities score, and a Hazards score for a property.

FIG. 3 exemplarily illustrates an interactive questionnaire displayed on a graphical user interface for receiving input data from users corresponding to twenty-eight variables used in the fire composite score model, referred to as the second set of variables.

FIGS. 4A-4F illustrate a fire composite score reference table that lists scores to be used for each variable used in a fire composite score model.

FIG. 5 illustrates a variable list table listing all forty-eight variables used in a fire composite score model.

FIG. 6 illustrates a tabular representation of individual scores of all forty-eight variables and a 4score, as also a graphical representation of four category scores comprising a Fuel score, an Ignitions score, a Susceptibilities score, and a Hazards score, on a graphical user interface.

FIG. 7 illustrates a tabular representation of individual scores of a first set of variables derived from geospatial artificial intelligence (GEOAI) and Big Data, and a PhiChi score computed from the first set of variables.

FIG. 8 illustrates a table listing a second set of variables derived from input data received from property owners, underwriters or other users, and individual scores assigned to each variable in a second set of variables.

FIG. 9 illustrates a tabular representation of individual scores of all forty-eight variables and a 4score, as also a graphical representation of four category scores comprising a Fuel score, an Ignitions score, a Susceptibilities score, and a Hazards score, on a graphical user interface, after applying the recommendations suggested by the fire composite score computation system of FIG. 2.

FIGS. 10A-10B illustrate a tabular representation of recommendations provided by the fire composite score computation system of FIG. 2 for all forty-eight variables of FIG. 5.

FIG. 11 is an example of output provided to consumers who purchase a fire composite score on the Black Swan website, www.blackswan4score.com.

FIG. 12 illustrates transformation of data as the data flows through a fire composite score computation system.

FIG. 13A illustrates a graph showing distribution of policies by Fireline score along with the expected average annual loss for risks in each category of Fuel, Ignitions, Susceptibilities, and Hazards.

FIG. 13B illustrates a graph showing goodness of fit test for Fireline.

FIG. 14A illustrates a graph showing distribution of policies by PhiChi score along with the expected average annual loss for risks in each category of Fuel, Ignitions, Susceptibilities, and Hazards.

FIG. 14B illustrates the PhiChi score's coefficient of determination for same locations as in FIG. 14A, using a 5^{th} degree polynomial fit.

FIG. 14C illustrates a resultant comparison chart that shows that the FCT score increases as Pure Premium increases.

### DETAILED DESCRIPTION OF THE INVENTION

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of the component referenced by a numeral in a drawing is applicable to the description of that component shown by that same numeral in any subsequent drawing herein.

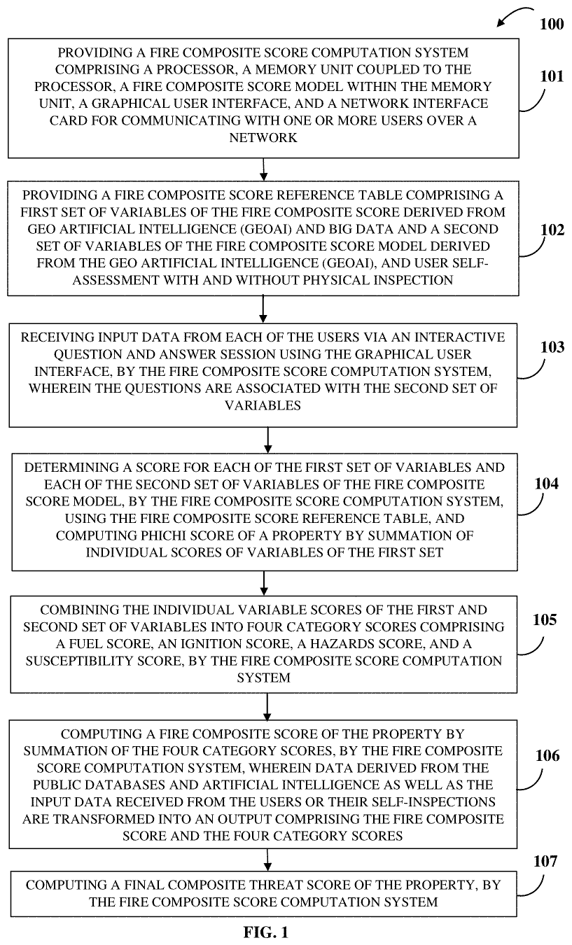

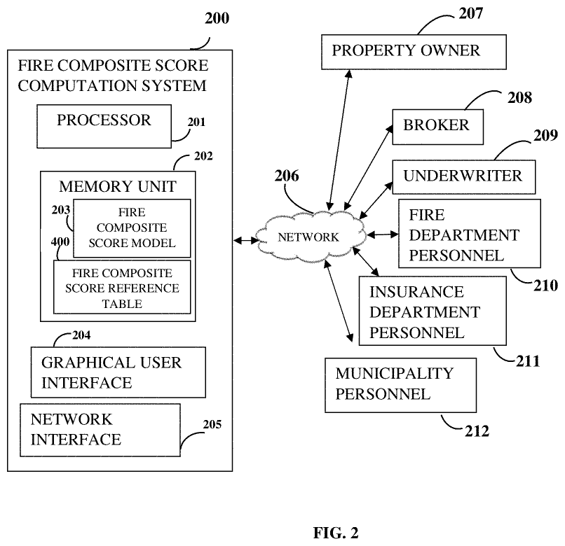

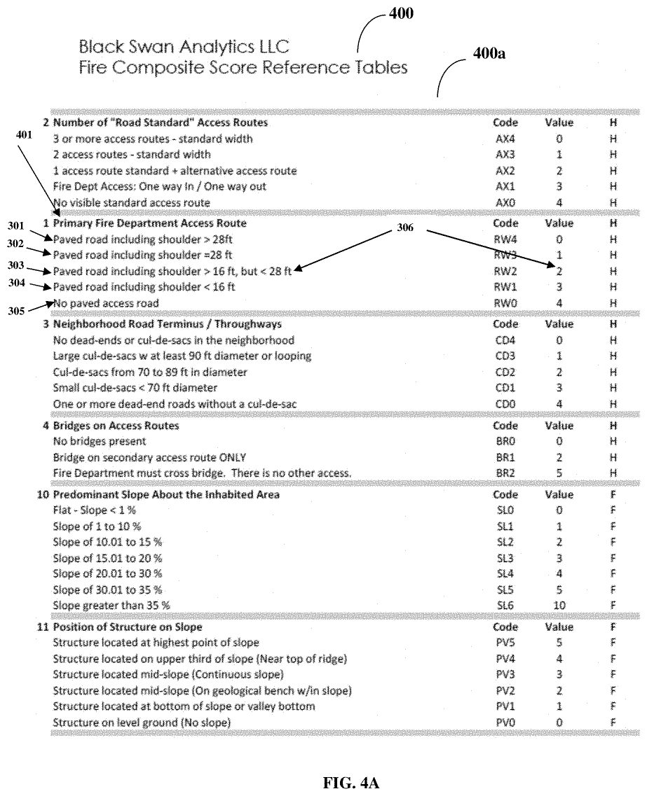

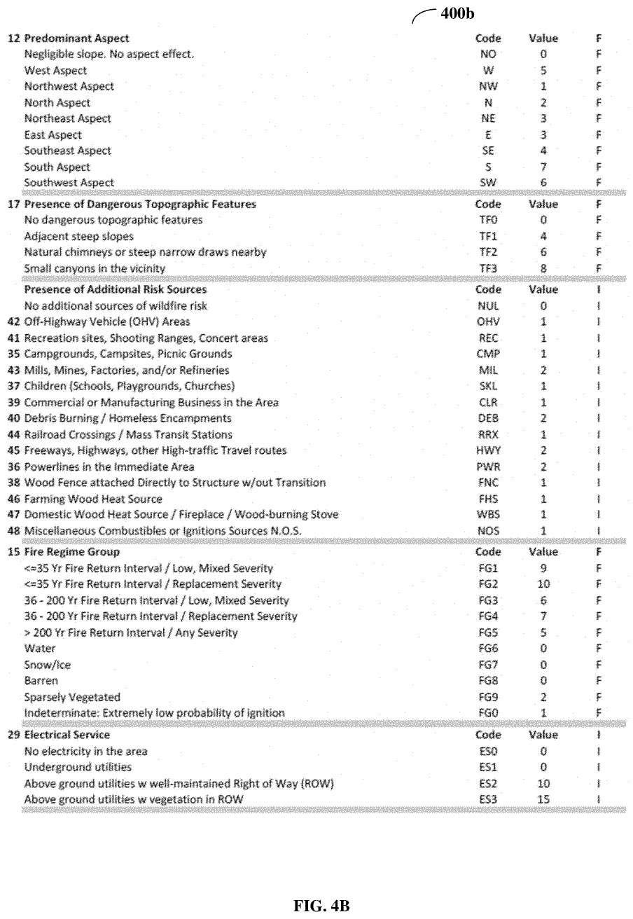

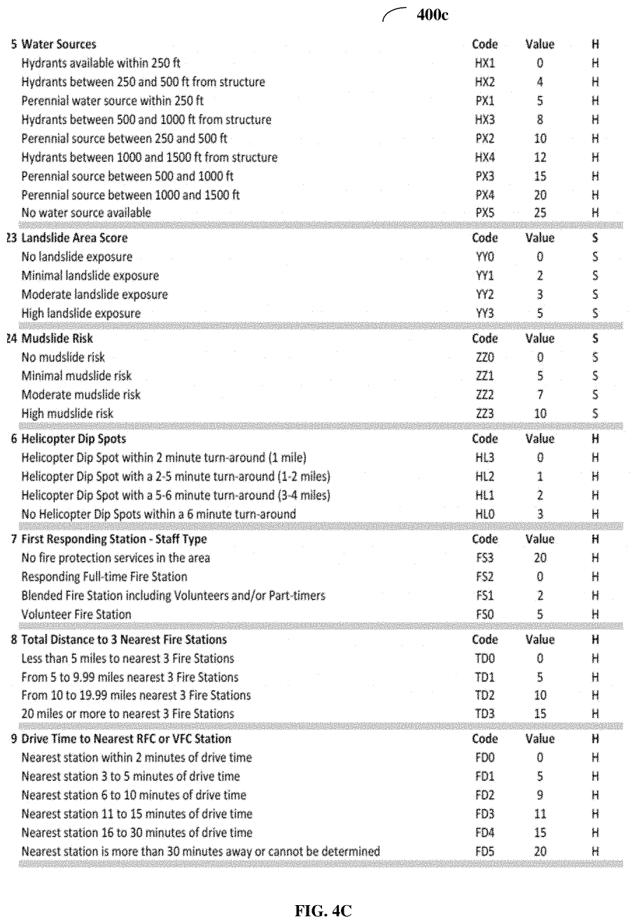

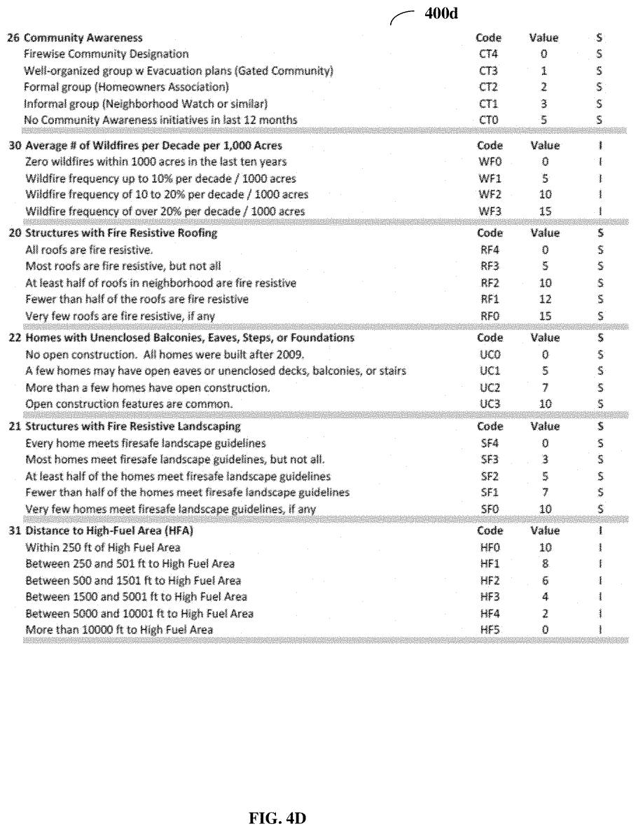

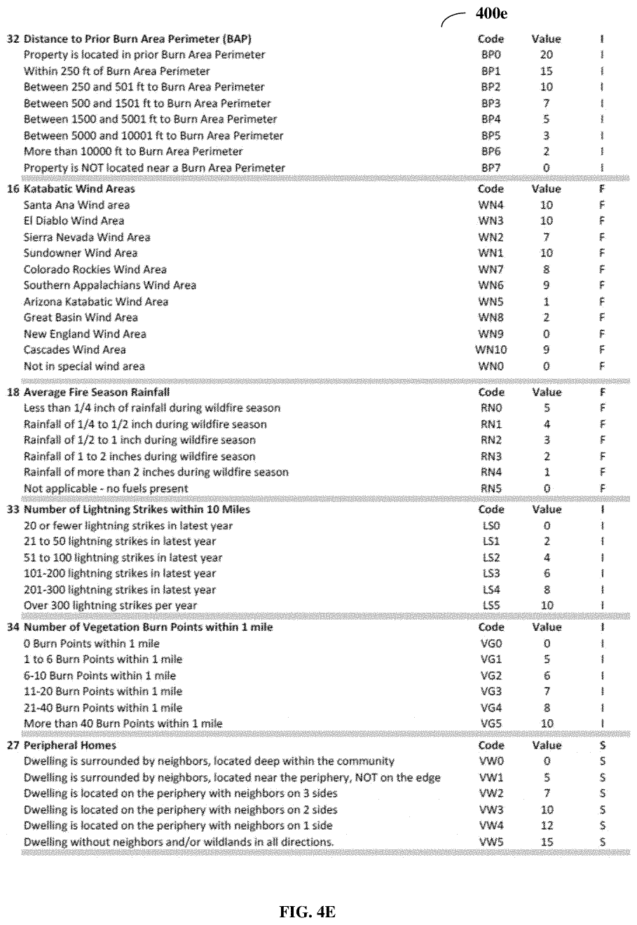

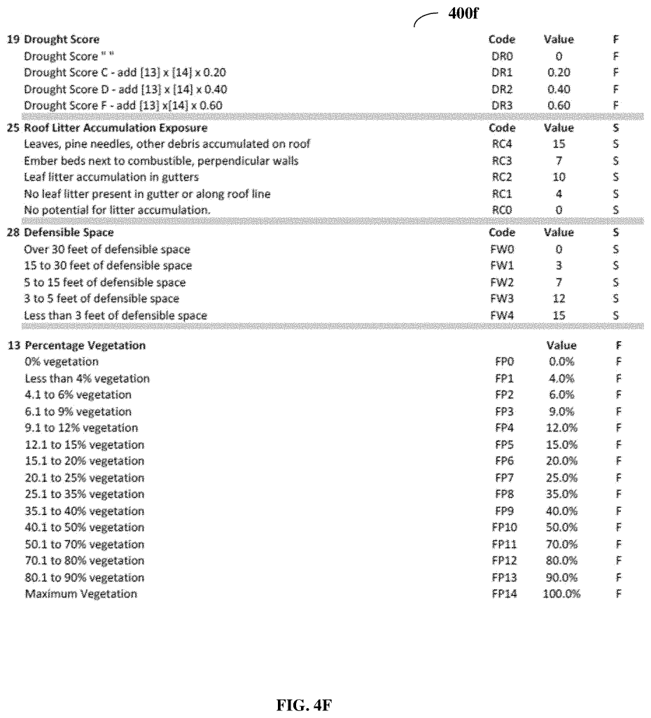

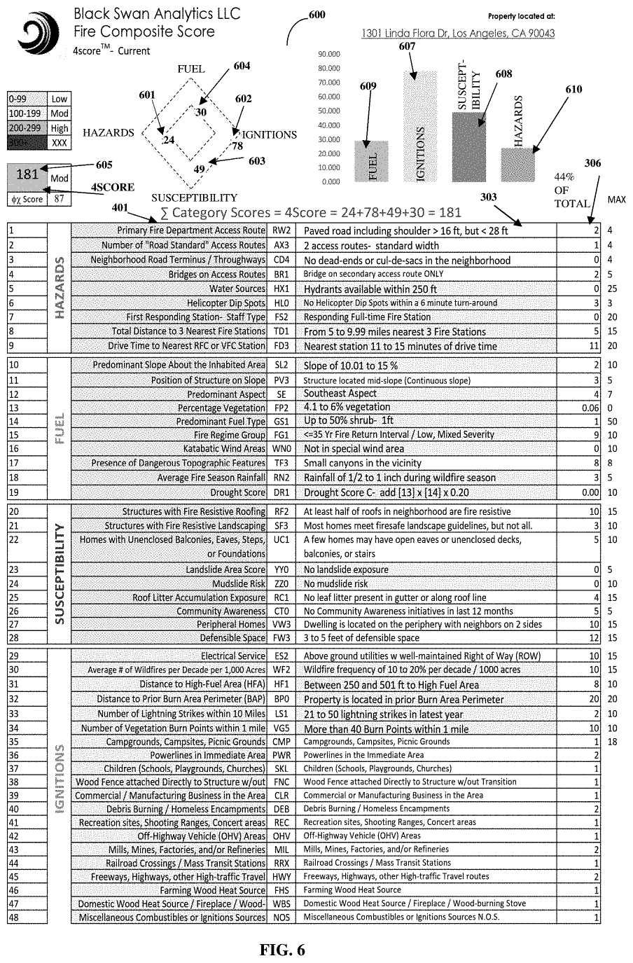

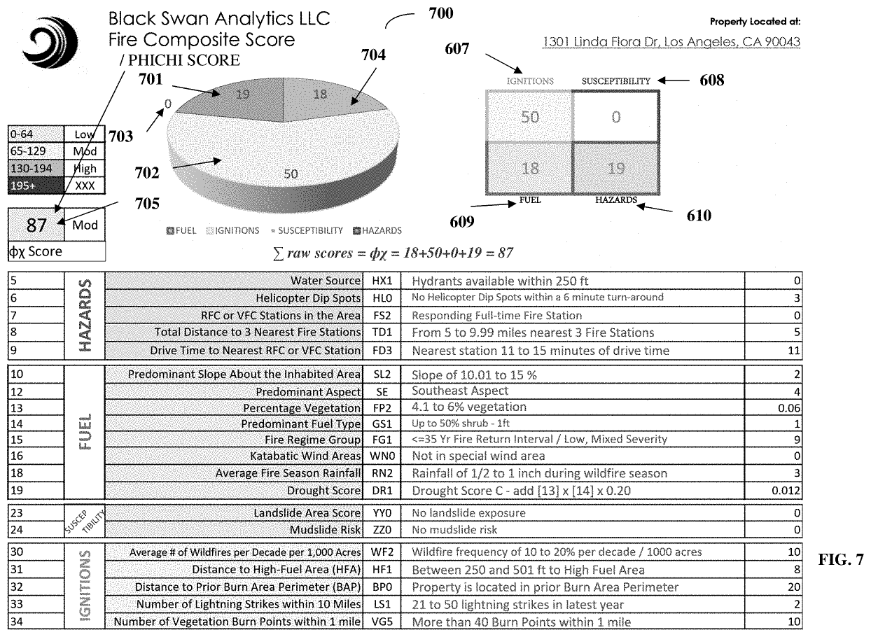

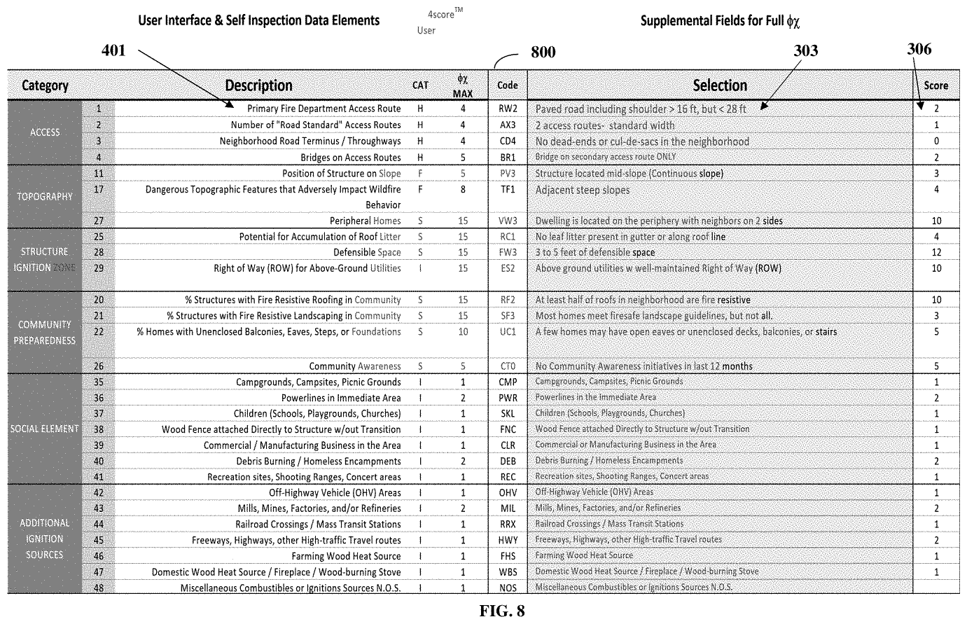

FIG. 1 exemplarily illustrates a method 100 for computing a PhiChi score 705, a complete fire composite score, or 4score, 605, a Final Composite Threat (FCT) Score 1203, and four category scores comprising a fuel score 604, an ignition score 602, a susceptibility score 603, and a hazards score 601, as shown in FIGS. 6-7, 9, 12 and Table-t. The method comprises providing 101 a fire composite score computation system 200, illustrated in FIG. 2. The fire composite score computation system 200 comprises a processor 201, a memory unit 202 coupled to the processor 201, a fire composite score model 203 within the memory unit 202, a graphical user interface 204, and a network interface card 205 for communicating with one or more users 207-212 over a network 206. The users 207-212 comprise, for example property owners 207, brokers 208, underwriters 209, fire department personnel 210, insurance department personnel 211, and municipality personnel 212. In a first aspect of the present invention, the method further comprises providing 102 a fire composite score reference table 400 shown in FIG. 4, comprising a first set of variables of the fire composite score model 203 derived from geospatial artificial intelligence (GEOAI) and wildfire data available in public databases to compute the PhiChi score 705 as shown in FIG. 7, and a second set of variables of the fire composite score model 203 shown in a table 800 in FIG. 8. The second set of variables are derived from user 207-212 input, self-inspection tools, and/or geospatial artificial intelligence (GEOAI). The first and the second set of variables are used to derive the 4score 605, and the four category scores comprising the fuel score 604, the ignitions score 602, the susceptibility score 603, and the hazards score 601. The four category scores are also used to derive the final composite threat (FCT) score 1203.

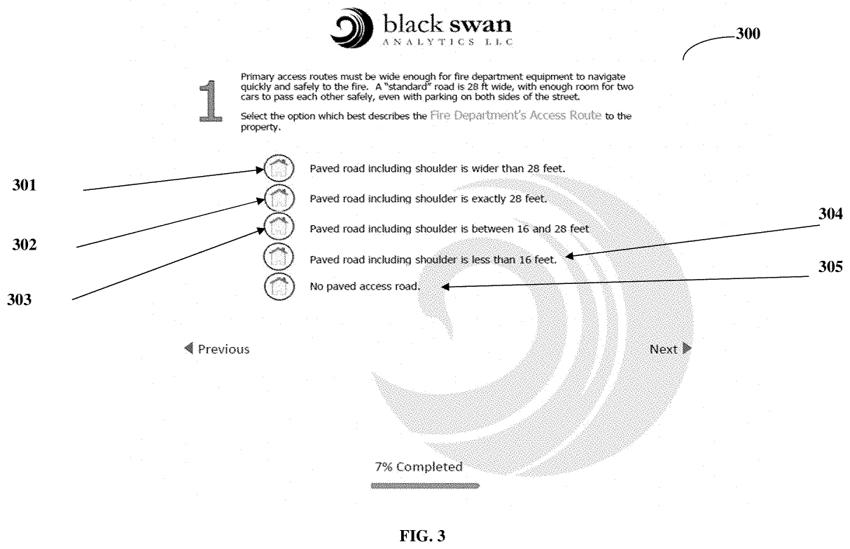

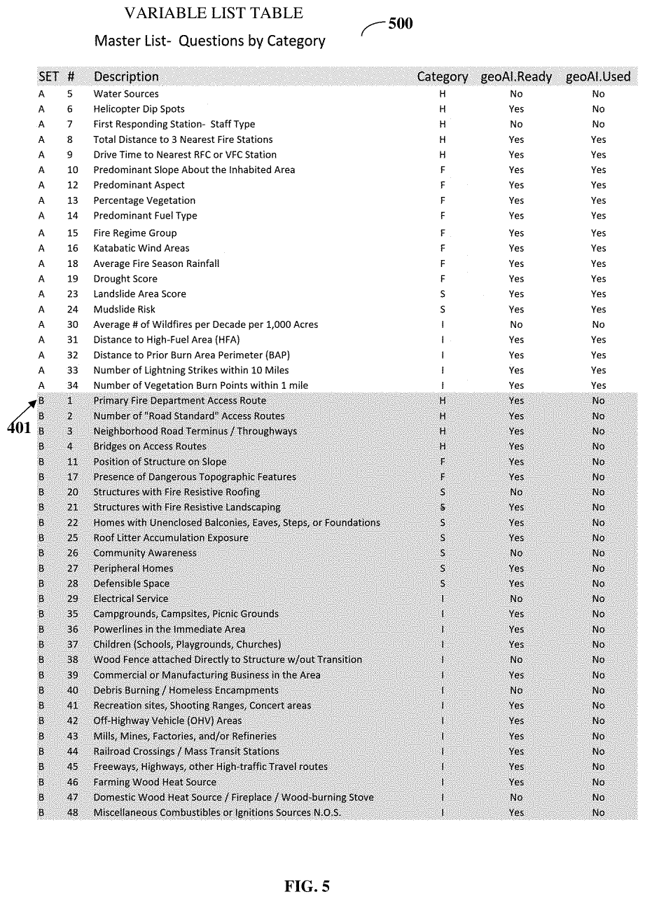

In an embodiment, the fire composite score model 203 is based on a set of forty-eight comprehensive and qualitative variables that are used to compute the fire composite score 605 of the property as shown in FIG. 6, using the fire composite score model 203. The set of forty-eight variables are listed in a table 500 shown in FIG. 5. Twenty variables out of the fifty variables form the first set of variables and are used to compute the PhiChi Score 705 shown in FIG. 7. In a second aspect of the present invention, twenty-eight variables out of the forty-eight variables form the second set of variables. If geospatial artificial intelligence (GEOAI) is not available for these variables, the fire composite score computation system receives 103 the input data from each of the users 207-212 via an interactive question and answer session 300 using the graphical user interface 204, as shown in FIG. 3. The questions are associated with the twenty-eight variables forming the second set of variables. In a third aspect of the present invention, a score is assigned to each of the first set of variables and each of the second set of variables in the fire composite score model 203 using the fire composite score reference table 400, as shown in FIG. 6. A plurality of options 301-305 are provided to the users 207-212 for each variable as illustrated in FIG. 3, and users 207-212 select one or more options based on the question presented to them. In an example, a homeowner 207, selects option 303 for the question related to a variable “Primary Fire Department Access Route” 401.

In a fourth aspect of the present invention, the fire composite score computation system 200 determines 104 score for each of the first set of variables and each of the second set of variables. In the example shown in FIGS. 6 and 8, the fire composite score computation system 200 assigns a score of 2 for the variable “Primary Fire Department Access Route” 401, as shown in FIG. 8. The fire composite score computation system 200 then computes the PhiChi score 705 of a property by applying mathematical formulae to the scores for each variable of the first set, as shown in FIG. 7. PhiChi, is written as “φχ” with f (Phi) being the Greek letter for “φ” and c (Chi) the Greek letter for “χ”. For a sample property with property address: 1301 Linda Flora Drive, Los Angeles, Calif., USA, the φχ score is calculated as 87.

In a fifth aspect of the present invention, the fire composite score computation system 200 combines 105 the individual variable scores into four category scores comprising a fuel score 604, an ignitions score 602, a susceptibility score 603, and a hazards score 601, as illustrated in table and graph 600 of FIG. 6.

In a sixth aspect of the present invention, the fire composite score computation system 200 computes 106 the 4score 605 of the property by summing the four category scores.

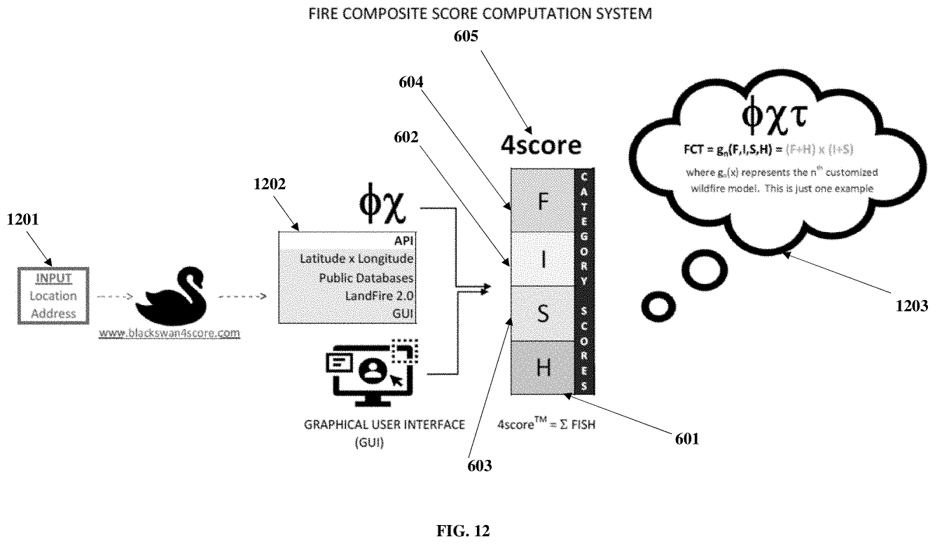

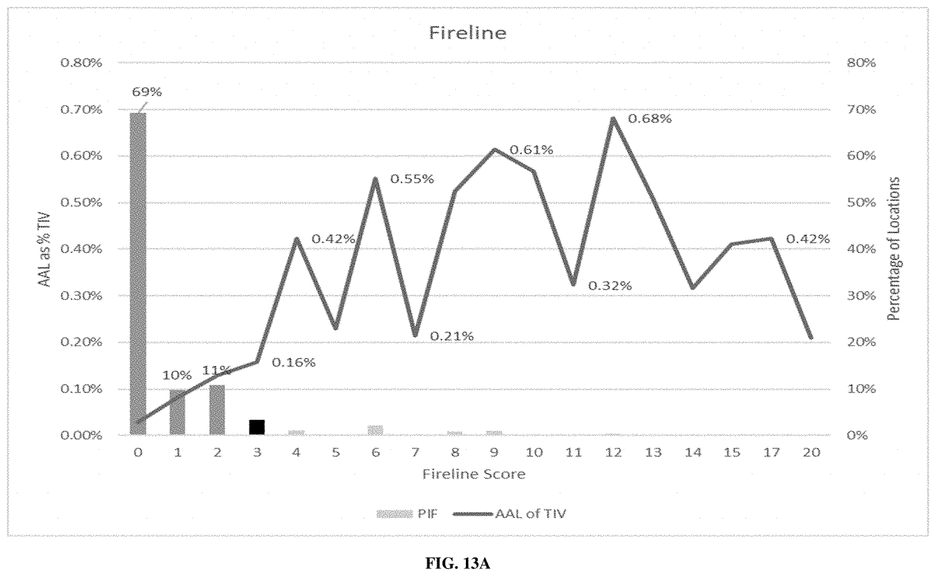

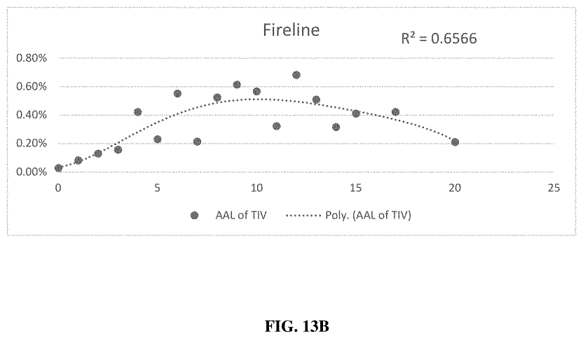

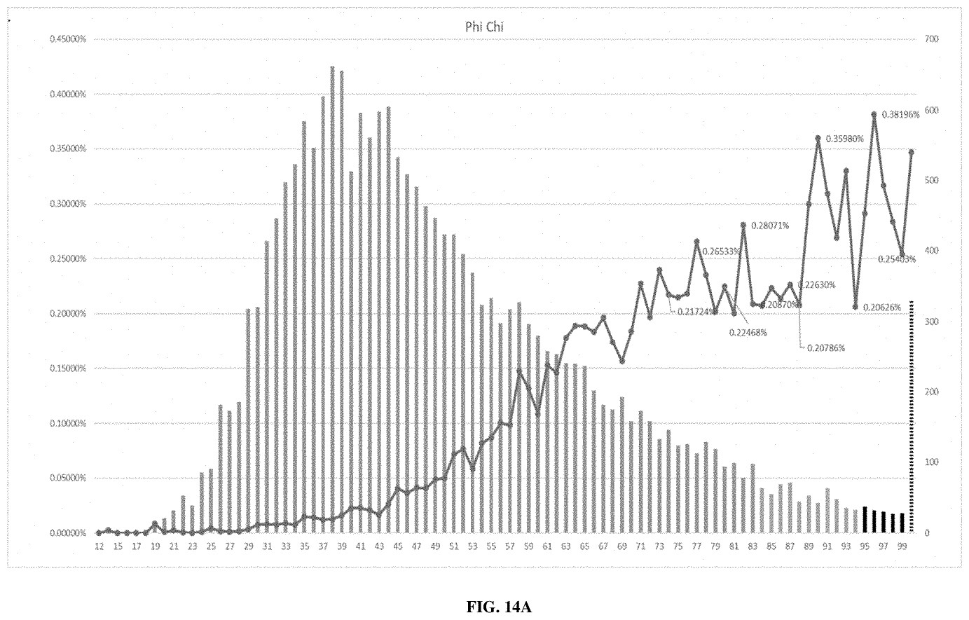

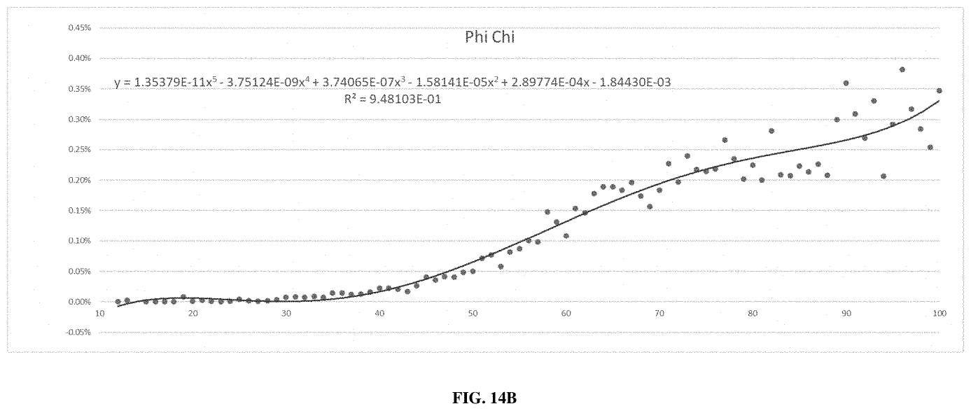

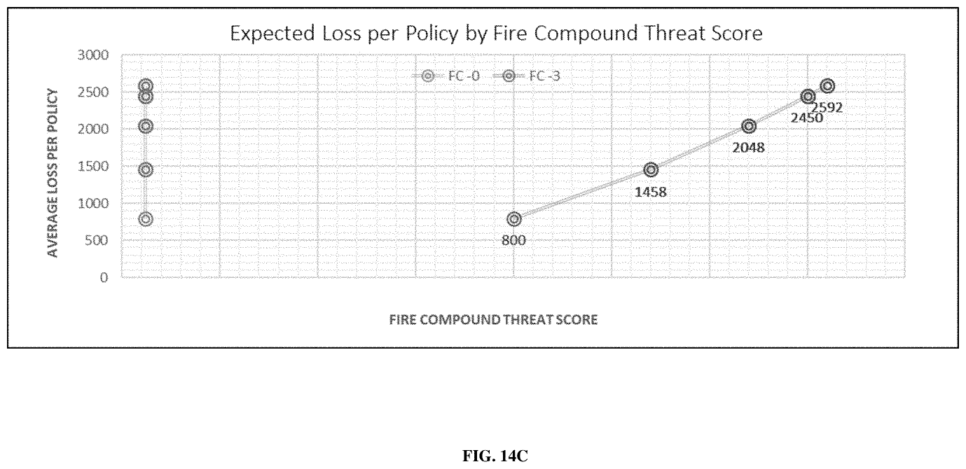

In a seventh aspect of the present invention, the fire composite score computation system 200 computes 107 the final composite threat (FCT) score 1203 of the property. The fire composite score computation system 200 transforms data 1201 derived from geospatial artificial intelligence (GEOAI), public databases and/or input data received from the users 207-212 into an output comprising the PhiChi score 705, the 4score 605, the final composite threat (FCT) score 1203, and the Category Scores 601-604, as shown in FIG. 12. The computed 4score 605 is the complete fire composite score for a property computed using the fire composite score model 203 and the comprehensive list of 48 variables in the fire composite score reference table 400. The PhiChi score ranges from 0 to 280 and the 4score ranges from 0 to 400. Furthermore, the 4score 605 of the property may be transformed, by applying actuarial methods to Category Scores and developing customized algorithms, into the Final Composite Threat (FCT) score, the FCT score 1203, of the property, thereby providing the most applicable measure of wildfire loss propensity. For a sample property with property address: 1301 Linda Flora Drive, Los Angeles, Calif., USA, the 4score is calculated as 181, and the four category scores calculated are 30 for the fuel category 609, 78 for the ignitions category 607, 49 for the susceptibility category 608, and 24 for the hazards category 610. The Final Composite Threat (FCT) score 1203 is calculated by the formula: FCT score=(Ignition score+Susceptibilities score)*(Fuel score+Hazards score)=(127*54)=6858.

FIG. 2 exemplarily illustrates a fire composite score computation system for computing a PhiChi score 705, a fire composite score 605, a Final Composite Threat (FCT) score, and four category scores comprising a fuel score 604, an ignitions score 602, a susceptibility score 603, and a hazards score 601 for a property. The fire composite score computation system 200 comprises a processor 201, a memory unit 202 coupled to the processor 201, a fire composite score model 203 within the memory unit 202, a graphical user interface 204, and a network interface card 205 for communicating with one or more users 207-212 over a network 206. A fire composite score reference table 400 is stored within said memory unit 202. The fire composite score reference table 400 comprises a first set of variables of the fire composite score model 203 derived from public data and geospatial artificial intelligence (GEOAI) and a second set of variables of the fire composite score model 203 derived from users 207-212.

The processor 201 of the fire composite score computation system 200 is configured to receive input data from each of the users 207-212 via an interactive question and answer session using the graphical user interface 204 as illustrated in FIG. 3. The input data received from the users 207-212 correspond to the twenty-eight variables. The questions are associated with the twenty-eight variables in the second set. A plurality of options is provided to the users 207-212, for example homeowners 207, for each variable as illustrated in FIG. 3, and homeowners 207 select one or more options based on the question presented to them. In an example, a homeowner 207 selects option 303 for the question related to a variable “Primary Fire Department Access Route” 401.

The processor 201 of the fire composite score computation system 200 is further configured to determine a score for each of the first set of variables and each of the second set of variables using the fire composite score reference table 400 illustrated in FIG. 4. The scores are computed for all the forty-eight variables in four categories as shown in FIG. 6. The forty-eight variables comprise the twenty variables derived from geospatial artificial intelligence (GEOAI) and Big Data, and the twenty-eight variables derived from the input data received from the users 207-212, as shown in a table 500 in FIG. 5. The four categories comprise a fuel category 609, an ignitions category 607, a susceptibility category 608, and a hazards category 610 as shown in FIG. 6. In an example, the fire composite score computation system 200 assigns a score of 2 for the variable “Primary Fire Department Access Route” 401, as shown in FIGS. 6, 8 and 9.

The processor 201 of the fire composite score computation system 200 is further configured to combine the individual variable scores into four category scores comprising a fuel score 604, an ignitions score 602, a hazards score 601, and a susceptibility score 603.

The processor 201 of the fire composite score computation system 200 is further configured to compute the 4score 605 of the property by summing the Category Scores 601-604. Further computation using concepts of actuarial science transforms data 1201 derived from the public databases and geospatial artificial intelligence (GEOAI), and the input data received from the users 207-212, using customized algorithms into a Final Composite Threat (FCT) score 1203 for advanced ratemaking methods. Furthermore, the PhiChi score 705 of the property was transformed, by incorporating additional information, into the 4score 605 of the property, thereby providing a complete fire composite score reflecting a comprehensive assessment of the wildfire risk of the property.

In an embodiment, the fire composite score computation system 200 assigns weights to each of the four category scores 601-604 before the summation of the four category scores 601-604 into the fire composite score 605. The weights are assigned to each of the four category scores based on historical data.

FIG. 3 exemplarily illustrates an interactive questionnaire displayed on a graphical user interface for receiving input data from users 207-212 corresponding to twenty-eight variables of the second set of variables. The twenty-eight variables used in the questionnaire is shown in a table 800 in FIG. 8. The questionnaire presents each variable of the second set of variables to the users 207-212 with one or more options for the answers selectable by the users 207-212. The users comprise, for example homeowners or property owners 207, brokers 208, underwriters 209, fire department personnel 210, insurance department personnel 211, and municipality personnel 212. For example, the variable presented in FIG. 3 is “Primary Fire Department Access Route” 401, and there are five choices for the users 207-212 to input their answers. Similarly, the fire composite score computation system 200 receives the input data from the users 207-212 to all the twenty-eight variables as illustrated in FIG. 8. In total, thirteen questions are presented to the users 207-212 to receive the input data for the twenty-eight variables.

FIGS. 4A-4F illustrate a fire composite score reference table 400 that lists scores to be used for each of the forty-eight variables used in a fire composite score model 203. The table 400 comprises tables 400a-400f as shown in FIGS. 4A-4F. When users 207-212 present their answers to a set of thirteen questions, the processor 201 of the fire composite score computation system 200 refers to fire composite score reference table 400 and assigns a score for each of twenty-eight variables based on the answers provided by the users 207-212. For example, if a property owner 207 picks the third choice “Paved road including shoulder >16 ft, but <28 ft”, then the processor 201 of the fire composite score computation system 200 assigns a score of 2 to the variable “Primary Fire Department Access Route” as illustrated in FIG. 6. Similarly, the fire composite score computation system 200 assigns scores to remaining twenty-eight variables as illustrated in FIG. 6 based on answers to other questions presented to the users 207-212 in the questionnaire of FIG. 3 and by reference to the fire composite score reference table 400 of FIG. 4. Furthermore, the scores for the twenty variables derived from the public databases is picked from the fire composite score reference table 400 and inserted into a table 600 shown in FIG. 6.

FIG. 5 illustrates a variable list table 500 listing all forty-eight variables used in a fire composite score model 203. Based on an extensive survey of potential users 207-212 and twenty five years pricing and underwriting property insurance, an exhaustive and qualitative set of the forty-eight variables have been identified for providing data input to the fire composite score model 203, which uses actuarial science to transform the data 1201 derived from the public databases and geospatial artificial intelligence (GEOAI) together with input data received from the users 207-212, using customized algorithms, into an output comprising a PhiChi score 705, the 4score 605, the fuel composite threat (FCT) score 1203, and four category scores 601-604 comprising a fuel score 604, an ignitions score 602, a hazards score 601, and a susceptibility score 603. Furthermore, the PhiChi score 705 of the property was transformed, by incorporating additional information, into the 4score 605 of the property, thereby providing a complete fire composite score reflecting a comprehensive assessment of the wildfire risk of the property. The concepts of actuarial science used in the present invention comprise mathematical and statistical methods. The variables comprise twenty variables available through geospatial artificial intelligence (GEOAI) and/or publicly available databases, as shown in table 700 of FIG. 7, and twenty-eight variables selected based on the input data received from the users 207-212 in response to questionnaire, as shown in a table 800 of FIG. 8.

The forty-eight variables are grouped into four categories. The four categories are fuel category 609, ignitions category 607, susceptibility category 608, and hazards category 610.

The variables in the fuel category 609 comprise the predominant slope about the inhabited area, slope position of value, predominant aspect, fuel amount, predominant fuel type, fire regime group, proximity to katabatic wind areas, presence of dangerous topographic features, average fire season rainfall, and presence of drought conditions in the last 12 months.

The variables in the ignitions category 607 comprise the type of electrical service, average number of wildfires per decade per 1,000 acres, distance to high-fuel area (HFA), distance to prior burn area perimeter (BAP), number of lightning strikes within 10 miles, number of vegetation burn points within 1 mile, presence of recreation sites, campgrounds, campsites, picnic grounds, mills or mines, locations for social gatherings, transportation routes including mass transit vehicle routes and railroads in the immediate area, location of powerlines or wooden fences that penetrate defensible space, presence of wood heat sources and other combustibles. The recreation sites comprise gun clubs, off-highway vehicle (OHV) area, and concert sites, and the locations for social gatherings comprise schools, business, and homeless encampments.

The variables in the hazards category 610 comprise number of “road standard” egress access routes, road surface width on primary access route, secondary road terminus, bridges on access routes, water sources, helicopter dip spots, regular full-time, blended, or volunteer fire department stations in the area, total distance to nearest fire stations, and drive time to nearest responding fire station.

The variables in the susceptibility category 608 comprise mudslide risk, landslide area score, structures with fire resistive roofing, homes with unenclosed balconies/eaves/steps/foundations, roof complexity, community awareness, peripheral homes, defensible space, percentage of homes with fire resistive landscaping, and urban conflagration.

FIG. 6 illustrates a tabular representation of individual scores of all forty-eight variables and an overall fire composite score, referred to as 4score 605, as also a graphical representation of four category scores comprising a fuel score 604, an ignitions score 602, a hazards score 601, and a susceptibility score 603, on a graphical user interface. In the graph, a risk level is assigned to each of the four category scores. The risk levels are used to provide recommendations to property owners to further improve the 4Score and the four category scores. Furthermore, as an example, fire composite score computation system 200 has assigned a score of 2 for the variable “Primary Fire Department Access Route” 401.

With the fire composite score model 203, consumers are never left in the dark. Every data element used in quantification of risk is provided to the users 207-212. It is not a black box leaving users 207-212 powerless or without understanding of their true exposure to loss caused by wildfire. The fire composite score model reveals all the underlying data to the users 207-212 with full transparency providing a dispute resolution process to ensure the data is accurate. This also gives the users 207-212 insight into ways to reduce their wildfire exposure and keep their insurance costs down; something the current models in insurance market do not offer.

The fire composite score model 203 does more than create homogeneous groupings. It goes one step further to differentiate properties with the same PhiChi score 705 by evaluating the risk in a different way. In addition to the PhiChi score 705 that ranges from 0 to 280, the four category scores comprising a fuel score 604, an ignition score 602, a susceptibility score 603, and a hazard score 601 are utilized to differentiate properties with the same PhiChi score 705 and very different risk profiles. Only those with same ratios between each of the four category scores 601-604 and the 4score 605, and further having the same PhiChi score 705, are grouped together, and are expected to perform identically. This gives a carrier ultimate control over pricing and resulting loss ratios.

FIG. 7 illustrates a tabular representation of individual scores of a first set of variables derived from geospatial artificial intelligence (GEOAI) and Big Data, and a PhiChi score computed from the first set of variables. The fire composite score computation system 200 determines a PhiChi score 705 based on applying mathematical formulae to the individual variables of the first set. The fire composite score model 203 computes the PhiChi score 705 of a property using only 20 variables of the first set. For the sample property with property address: 1301 Linda Flora Drive, Los Angeles, Calif., USA, the PhiChi score 705 determined by the fire composite score model 203 is 87.

FIG. 8 illustrates a table 800 listing a second set of variables derived from input data received from users 207-212, and individual scores assigned to each variable in the second set of variables. In an example, fire composite score computation system 200 assigns a score of 2 for the variable “Primary Fire Department Access Route” 401, based on answer provided by a homeowner 207.

The fire composite score computation system 200 of the present invention combines the first and second set of variables into a comprehensive and qualitative set of forty-eight variables as shown in the table 600 in FIG. 6. The fire composite score model 203 of the present invention uses this full set of forty-eight variables for computing a 4score and four category scores comprising a fuel score 604, an ignitions score 602, a hazards score 601, and a susceptibility score 603. As seen in FIG. 6, the 4score 605 for the property address: 1301 Linda Flora Drive, Los Angeles, Calif., USA is 181. Similarly, the four category scores as determined by the fire composite score model 203 of the present invention is 30 for a fuel category 609, 24 for a hazards category 610, 49 for a susceptibility category 608, and 78 for the ignitions category 607. Furthermore, the fire composite score computation system 200 has assigned moderate risk level to the Fuel and the Hazards categories, high risk level for the Susceptibilities category, and very high risk for the Ignitions category. Furthermore, the final composite threat (FCT) score 1203 is calculated by the formula: FCT score=(Ignition score+Susceptibilities score)*(Fuel score+Hazards score)=(127*54)=6858. As seen by comparison between FIG. 6 and FIG. 7, and by reference to Table-1, the present invention provides a more realistic picture of wildfire exposure for a property, which is a big boon to users 207-212 for demonstrating underwriting acceptability with insurance carriers. From a different perspective, the present invention provides the insurance carriers with ultimate control over pricing and resulting loss ratios.

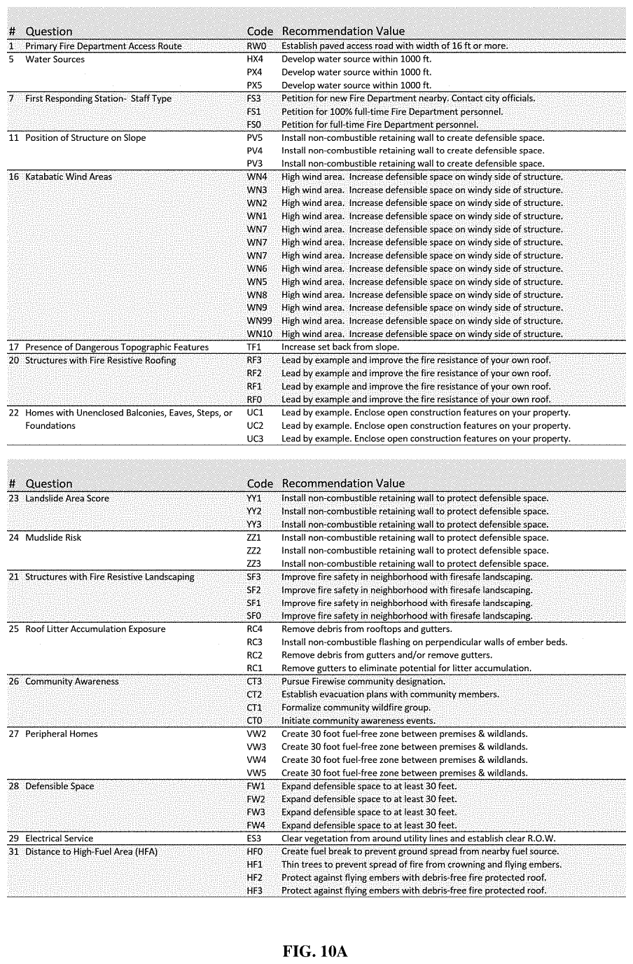

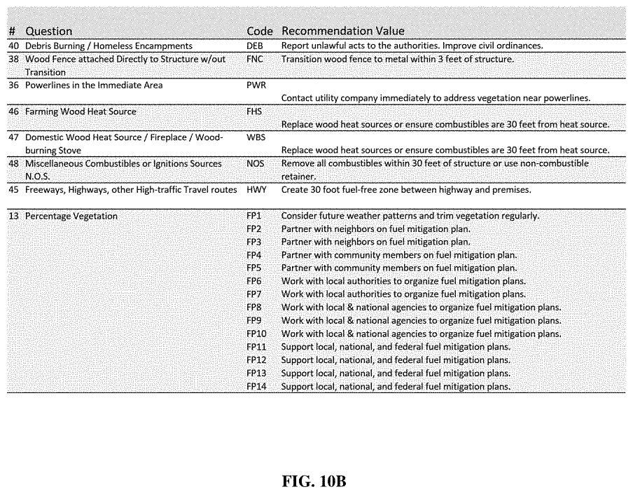

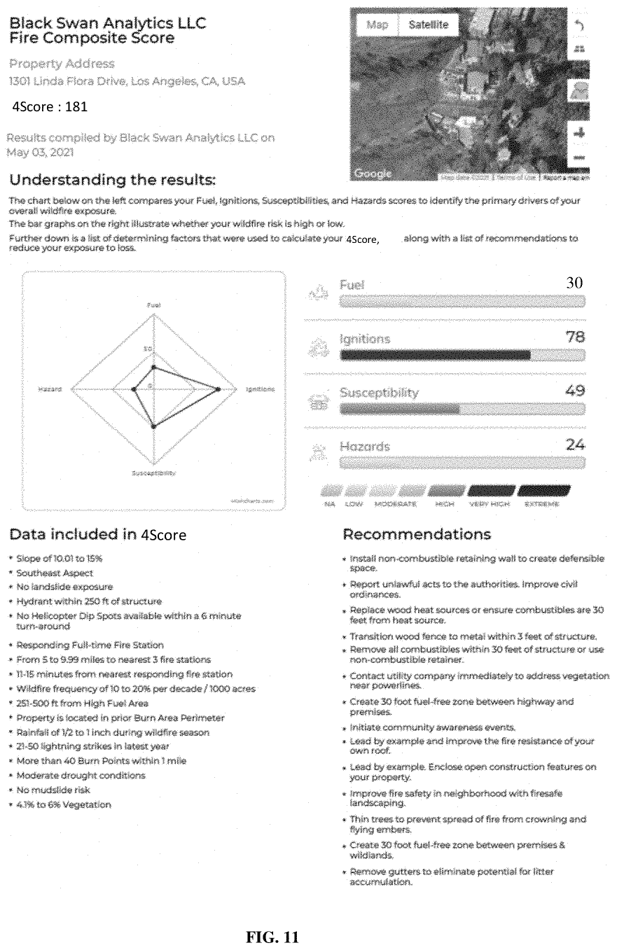

FIG. 11 is an example of output provided to consumers who purchase a fire composite score on the Black Swan website, www.blackswan4score.com. Recommendations shown are derived according to each fire composite score code from Recommendations table in FIGS. 10A-10B. For example, for the property address: 1301 Linda Flora Drive, Los Angeles, Calif., USA, the system provides the following recommendations:
Increase defensible space around the structure. Use a non-combustible retaining wall to stop rolling firebrands from above.
Transition wood fence to non-combustible within 3 to 5 feet of structure.
Remove miscellaneous combustibles around the premises or enclose them in a non-combustible container.
If vegetation is touching or nearly touching the powerlines, contact your utility company immediately to address the hazard.
Establish a community group focused on wildfire defense by enlisting support from other concerned neighbors.
Raise awareness in the community by supporting wildfire preparedness. Lead by example with a fire resistive roof.
Raise awareness in the community by supporting wildfire preparedness. Lead by example with a firesafe landscape.
Continue maintaining litter-free roof.
Increase defensible space to at least 5 feet.

Data derived from Big Data and GeoAI for computing the various scores as shown in FIGS. 6, 7, and 9 are:
Slope of 10.01 to 15%
Southeast Aspect
No landslide exposure
Hydrant within 250 ft of structure
No Helicopter Dip Spots available within a 6-minute turn-around
Responding Full-time Fire Station
From 5 to 9.99 miles to nearest 3 fire stations
11-15 minutes from nearest responding fire station
Wildfire frequency of 10 to 20% per decade/1000 acres
251-500 ft from High Fuel Area
Property is located in prior Burn Area Perimeter
Rainfall of ½ to 1 inch during wildfire season
21-50 lightning strikes in latest year
More than 40 Burn Points within 1 mile
Moderate drought conditions
No mudslide risk
4.1% to 6% Vegetation.

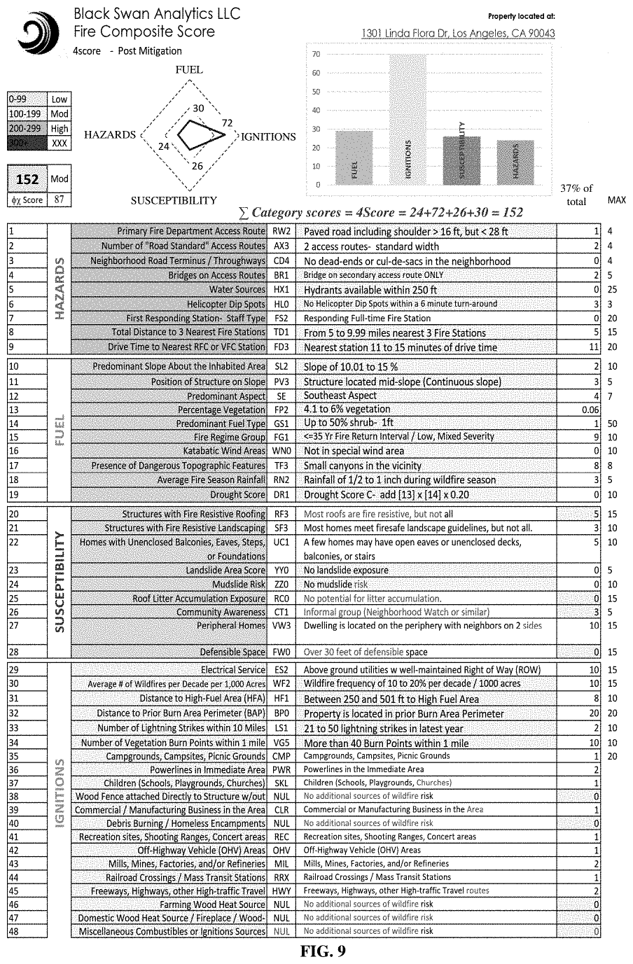

If the homemaker 207 implements all of the recommended mitigation strategies, the 4score 605 will be revised to 152, as illustrated in FIG. 9. The corresponding four category scores 601-604 will be 30 for the fuel score 604, 72 for the ignitions score 602, 26 for the susceptibility score 603, and 24 for the hazards score 601. The final composite threat (FCT) score 1203 will be 5292.

FIG. 12 illustrates transformation of data as the data flows through a fire composite score computation system 200. The fire composite score computation system 200 accepts data derived from geospatial artificial intelligence (GEOAI), public databases and/or input data received from users as input and uses an application program interface (API) 1202, concepts of actuarial science, geospatial artificial intelligence (GEOAI), Big Data available from various data amalgamators, and a comprehensive set of forty-eight variables to transform the input into an output comprising the PhiChi score, the 4score, the final composite threat (FCT) score 1203, and the Category Scores 601-604.

The method 100 and a system 200 disclosed herein contains patent-eligible subject matter and is not abstract as the specification discloses and the claims are directed to a practical application of providing a comprehensive assessment of a wildfire risk of a property.

The inventive concept disclosed in the method 100 and system 200 results in a technical improvement over existing systems, as the independent claim limitations disclosed herein do not recite “well-understood, routine, conventional activities previously known to the industry”. Conventional systems for assessment of a wildfire risk of a property only use a limited set of 3-5 variables to compute a fire assessment score for a property. In contrast, the present invention uses a comprehensive list of 48 variables (20 variables in the first list of variables in the fire composite score reference table 400 plus 28 variables in the second list of variables in the fire composite score reference table 400) to compute the composite fire assessment score 605 and the final composite threat (FCT) score 1203 for the property. The use of 48 variables to compute the composite fire assessment score 605 and the final composite threat (FCT) score 1203 for the property is unconventional and hitherto unknown in the property and casualty insurance industry.

The inventive concept of the method 100 and system 200 discloses that the data 1201 provided to the fire composite score computation system 200 is technically processed, executed and transformed into another set of data by using customized algorithms to arrive at a final step or end result of the invention, which is the composite fire assessment score 605 and the final composite threat (FCT) score 1203 for the property. More specifically, the data derived from the public databases and artificial intelligence as well as the input data received from the users or their self-inspections are transformed, by using the API 1202 and customized algorithms, into an output comprising the complete fire composite score (4score) 605, the final composite threat (FCT) score 1203, and the four category scores 601-604, thereby providing a comprehensive assessment of the wildfire risk of the property.

Furthermore, a generic computer cannot perform computations involving Geospatial artificial intelligence (GEOAI). Customized algorithms are required for such computations. More specifically, the method 100 and system 200 for computing a PhiChi score 705, a 4score 605, a Final Composite Threat (FCT) score 1203, and four category scores 601-604 comprising a fuel score 604, an ignitions score 602, a susceptibility score 603, and a hazards score 601, for a property, uses a comprehensive set of variables comprising a combination of a first set of variables derived from geospatial artificial intelligence, or GEOAI, and Big Data available from various data amalgamators, and a second set of variables that are derived from input received from the users through a self-assessment tool. In the future, it is contemplated that the second set of variables may be derived from geospatial artificial intelligence (GEOAI). The use of customized algorithms, geospatial artificial intelligence (GEOAI), and Big Data results in a significant improvement to computer technology, in addition to significant improvement to the property and casualty insurance industry.

The foregoing examples have been provided merely for explanation and are in no way to be construed as limiting of the method 100 and system 200 for computing a PhiChi score 705, a fire composite score 605, a Final Composite Threat (FCT) score 1203, and four category scores 601-604 comprising a fuel score 604, an ignitions score 602, a susceptibility score 603, and a hazards score 601, as disclosed herein. While the method 100 and system 200 for computing the PhiChi score 705, the fire composite score 605, the Final Composite Threat (FCT) score 1203, and the four category scores 601-604 comprising the fuel score 604, the ignitions score 602, the susceptibility score 603, and the hazards score 601 has been described with reference to a particular embodiment, it is understood that the words, which have been used herein, are words of description and illustration, rather than words of limitation. Furthermore, although the method 100 and system 200 for computing the PhiChi score 705, the fire composite score 605, the Final Composite Threat (FCT) score, and the four category scores 601-604 comprising the fuel score 604, the ignitions score 602, the susceptibility score 603, and the hazards score 601 has been described herein with reference to a particular means, materials, and embodiment, the method and system for computing the PhiChi score 705, the fire composite score 605, the Final Composite Threat (FCT) score 1203, and the four category scores 601-604 comprising the fuel score 604, the ignitions score 602, the susceptibility score 603, and the hazards score 601 is not intended to be limited to the particulars disclosed herein; rather, the design and functionality of the method 100 and system 200 for computing the PhiChi score 705, the fire composite score 605, the Final Composite Threat (FCT) score 1203, and the four category scores 601-604 comprising the fuel score 604, the ignitions score 602, the susceptibility score 603, and the hazards score 601 extends to all functionally equivalent structures and uses, such as are within the scope of the appended claims. Furthermore, it will be understood by those skilled in the art, having the benefit of the teachings of this specification, that the method 100 and system 200 for computing the PhiChi score 705, the fire composite score 605, the Final Composite Threat (FCT) score 1203, and the four category scores 601-604 comprising the fuel score 604, the ignitions score 602, the susceptibility score 603, and the hazards score 601 disclosed herein is capable of modifications and other embodiments may be effected and changes may be made thereto, without departing from the scope and spirit of the method and system for computing the PhiChi score 705, the fire composite score 605, the Final Composite Threat (FCT) score 1203, and the four category scores 601-604 comprising the fuel score 604, the ignitions score 602, the susceptibility score 603, and the hazards score 601, as disclosed herein.

I claim:

1. A method for determining a wildfire risk of a property, comprising computing a PhiChi score, a fire composite score (4score), a final composite threat (FCT) score, and four category scores comprising a fuel score, an ignitions score, a hazards score, and a susceptibility score, for the property, the method comprising:
a) providing a fire composite score computation system comprising a processor, a memory unit coupled to the processor, a fire composite score model within the memory unit, a graphical user interface, and a network interface card for communicating with one or more users over a network;
b) providing a fire composite score reference table comprising a first set of variables of the fire composite score model derived from Geo Artificial Intelligence (GEOAI) and Big Data, and a second set of variables of the fire composite score model derived from the geo artificial intelligence (GEOAI), and user self-assessment with and without physical inspection;
c) receiving input data from each of the users via an interactive question and answer session using the graphical user interface, by the fire composite score computation system, wherein the questions are associated with the second set of variables;
d) determining a score for each of the first set of variables and the second set of variables of the fire composite score model, by the fire composite score computation system, using the fire composite score reference table;
e) computing a PhiChi score of a property, by the fire composite score computation system, by applying mathematical formulae to individual scores of variables of the first set;
f) combining the individual scores of the first and second set of variables into four categories of scores comprising a fuel score, an ignitions score, a hazards score, and a susceptibility score, by the fire composite score computation system, using the fire composite score model, and presenting a graph of the four category scores together with associated risk levels;
g) computing the fire composite score of the property by summation of the four category scores, by the fire composite score computation system, wherein data derived from the public databases and artificial intelligence as well as the input data received from the users or their self-inspections are transformed, by using customized algorithms, into an output comprising the fire composite score and the four category scores, and wherein the baseline fire composite score, or PhiChi, is transformed, by using the customized algorithms, into the complete fire composite score of the property, the 4score, thereby providing a comprehensive assessment of the wildfire risk of the property; and
h) computing the final composite threat (FCT) score by the formula:
FCT score=(Ignition score+Susceptibilities score)*(Fuel score+Hazards score).

2. The method of claim 1, further comprising assigning weights to each of the four category scores before the summation into the complete fire composite score, by the fire composite score computation system.

3. The method of claim 1, wherein the variables in a fuel category comprise a predominant slope about the inhabited area, a slope position of value, a predominant aspect, a fuel amount, a predominant fuel type, a fire regime group, katabatic wind areas, presence of dangerous topographic features, an average fire season rainfall, and drought conditions.

4. The method of claim 1, wherein the variables in an ignitions category comprise an electrical service, an average number of wildfires per decade per 1,000 acres, distance to high-fuel area (HFA), distance to prior burn area perimeter (BAP), number of lightning strikes within 10 miles, number of vegetation burn points within 1 mile, recreation sites, campgrounds, campsites, picnic grounds, mills or mines, locations for social gatherings, transportation routes including mass transit vehicle routes and railroads, powerlines or wooden fences that penetrate defensible space, wood heat sources and other combustibles.

5. The method of claim 4, wherein the recreation sites comprise gun clubs, off-highway vehicle (OHV) area, and concert sites.

6. The method of claim 4, wherein the locations for social gatherings comprise schools, business, and homeless encampments.

7. The method of claim 1, wherein the variables in an hazards category comprise number of “road standard” egress access routes, road surface width on primary access route, secondary road terminus, bridges on access routes, water sources, helicopter dip spots, regular full-time, blended, or volunteer fire department stations in the area, total distance to nearest fire stations, and drive time to nearest responding fire station.

8. The method of claim 1, wherein the variables in a susceptibility category comprise mudslide risk, landslide area score, structures with fire resistive roofing, homes with unenclosed balconies/eaves/steps/foundations, roof complexity, community awareness, peripheral homes, defensible space, percentage of homes with fire resistive landscaping, and urban conflagration.

9. The method of claim 1, further comprising differentiating properties with same PhiChi score based on ratio between each of the four category scores and the 4score, wherein the properties with the same PhiChi score and same ratio between each of the four category scores and the 4score is grouped together.

10. The method of claim 1, wherein the weights are assigned to each of the four category scores based on the historical data.

11. The method of claim 1, wherein PhiChi score is written as “φχ” score, with φ being a Greek letter for ‘F’ and χ being the Greek letter for ‘C’, wherein the PhiChi score ranges from 0 to 280, and wherein the 4score, or the complete fire composite, ranges from 0 to 400.

12. The method of claim 1, further comprising presenting the scores in one or more of a table and a graph on the graphical user interface, by the fire composite score computation system, wherein the four category scores are presented as a percentage of maximum category score for all the variables in each of the four categories.

13. The method of claim 1, wherein concepts of actuarial science are used for the transformation of the input data to the Final Composite Threat (FCT) score, wherein the concepts of actuarial science comprise mathematical and statistical methods, and wherein the fire composite score computation system provides recommendations to property owners for further improving the 4score and the FCT score, based on the associated risk levels of the four category scores.

14. A fire composite score computation system for determining a wildfire risk of a property, comprising computing a PhiChi score, a fire composite score (4score), a final composite threat (FCT) score, and four category scores comprising a fuel score, an ignitions score, a hazards score, and a susceptibility score, for the property, the system comprising:
a) a processor;
b) a memory unit coupled to the processor;
c) a fire composite score model within the memory unit;
d) a fire composite score reference table stored within said memory unit, wherein the fire composite score reference table comprises a first set of variables of the fire composite score model derived from Geo Artificial Intelligence (GEOAI) and Big Data, and a second set of variables of the fire composite score model derived from the geo artificial intelligence (GEOAI), and user self-assessment with and without physical inspection;
e) a graphical user interface;
f) a network interface card for communicating with one or more users over a network;
g) said processor configured to receive input data from each of the users via an interactive question and answer session using the graphical user interface, wherein the questions are associated with the second set of variables;
h) said processor configured to determine a score for each of the first set of variables and the second set of variables of the fire composite score model, using the fire composite score reference table;
i) said processor configured to compute the PhiChi score of the property by applying mathematical formulae to the individual scores of variables of the first set;
j) said processor configured to combine the individual scores of the first and second set of variables into the four category scores comprising the fuel score, the ignitions score, the hazards score, and the susceptibility score, using the fire composite score model, and present a graph of the four category scores together with associated risk levels;
k) said processor configured to compute the 4score of the property by summation of the four category scores, wherein data derived from the public databases and artificial intelligence as well as the input data received from the users or their self-inspections are transformed, by using customized algorithms, into an output comprising the 4score and the four category scores, and wherein the PhiChi score of the property is transformed, by using customized algorithms, into the complete fire composite score of the property, thereby providing a comprehensive assessment of the wildfire risk of the property; and
l) said processor configured to compute the final composite threat (FCT) score by the formula:
FCT score=(Ignition score+Susceptibilities score)*(Fuel score+Hazards score).

15. The fire composite score computation system of claim 14, further comprising:
a) said processor configured to assign weights to each of the four category scores before the summation into the complete fire composite score, or 4score.

16. The fire composite score computation system of claim 14, wherein the variables in a fuel category comprise a predominant slope about the inhabited area, a slope position of value, a predominant aspect, a fuel amount, a predominant fuel type, a fire regime group, katabatic wind areas, presence of dangerous topographic features, an average fire season rainfall, and drought conditions.

17. The fire composite score computation system of claim 14, wherein the variables in an ignitions category comprise an electrical service, an average number of wildfires per decade per 1,000 acres, distance to high-fuel area (HFA), distance to prior burn area perimeter (BAP), number of lightning strikes within 10 miles, number of vegetation burn points within 1 mile, recreation sites, campgrounds, campsites, picnic grounds, mills or mines, locations for social gatherings, transportation routes including mass transit vehicle routes and railroads, powerlines or wooden fences that penetrate defensible space, wood heat sources and other combustibles.

18. The fire composite score computation system of claim 17, wherein the recreation sites comprise gun clubs, off-highway vehicle (OHV) area, and concert sites.

19. The fire composite score computation system of claim 17, wherein the locations for social gatherings comprise schools, business, and homeless encampments.

20. The fire composite score computation system of claim 14, wherein the variables in a hazards category comprise number of “road standard” egress access routes, road surface width on primary access route, secondary road terminus, bridges on access routes, water sources, helicopter dip spots, regular full-time, blended, or volunteer fire department stations in the area, total distance to nearest fire stations, and drive time to nearest responding fire station.

21. The fire composite score computation system of claim 14, wherein the variables in a susceptibility category comprise mudslide risk, landslide area score, structures with fire resistive roofing, homes with unenclosed balconies/eaves/steps/foundations, roof complexity, community awareness, peripheral homes, defensible space, percentage of homes with fire resistive landscaping, and urban conflagration.

22. The fire composite score computation system of claim 14, further comprising:
a) said processor configured to differentiate properties with same PhiChi score based on ratio between each of the four category scores and the 4score, wherein the properties with the same PhiChi score and same ratio between each of the four category scores and the 4score are grouped together.

23. The fire composite score computation system of claim 14, wherein the weights are assigned to each of the four category scores based on the historical data.

24. The fire composite score computation system of claim 14, wherein PhiChi is written as “φχ” score, with φ being a Greek letter for ‘F’ and χ being the Greek letter for ‘C’, wherein the PhiChi score ranges from 0 to 280, and wherein the 4score, or the complete fire composite, ranges from 0 to 400.

25. The fire composite score computation system of claim 14, further comprising:
a) said processor configured to present the scores in one or more of a table and a graph on the graphical user interface, by the fire composite score computation system, wherein the four category scores are presented as a percentage of maximum category score for all the variables in each of the four categories.

26. The fire composite score computation system of claim 14, wherein concepts of actuarial science are used for the transformation of the input data to the Final Composite Threat (FCT) score, wherein the concepts of actuarial science comprise mathematical and statistical methods, and wherein the fire composite score computation system provides recommendations to property owners for further improving the 4score and the FCT score, based on the associated risk levels of the four category scores.

27. A non-transitory computer readable storage medium having embodied thereon, computer program codes comprising instructions executable by at least one processor for determining a wildfire risk of a property, comprising computing a PhiChi score, a fire composite score (4score), a final composite threat (FCT) score, and four category scores comprising a fuel score, an ignitions score, a hazards score, and a susceptibility score, for the property, said computer program codes comprising:
a) a first computer program code for providing a fire composite score computation system comprising a processor, a memory unit coupled to the processor, a fire composite score model within the memory unit, a graphical user interface, and a network interface card for communicating with one or more users over a network;
b) a second computer program code for providing a fire composite score reference table comprising a first set of variables of the fire composite score model derived from Geo Artificial Intelligence (GEOAI) and Big Data, and a second set of variables of the fire composite score model derived from the geo artificial intelligence (GEOAI), and user self-assessment with and without physical inspection;
c) a third computer program code for receiving input data from each of the users via an interactive question and answer session using the graphical user interface, by the fire composite score computation system, wherein the questions are associated with the second set of variables;
d) a fourth computer program code for determining a score for each of the first set of variables and the second set of variables of the fire composite score model, by the fire composite score computation system, using the fire composite score reference table;
e) a fifth computer program code for computing a PhiChi score of a property, by the fire composite score computation system, by applying mathematical formulae to individual scores of variables of the first set;
f) a sixth computer program code for combining the individual scores of the first and second set of variables into four categories of scores comprising a fuel score, an ignitions score, a hazards score, and a susceptibility score, by the fire composite score computation system, using the fire composite score model, and presenting a graph of the four category scores together with associated risk levels;
g) a seventh computer program code for computing the fire composite score of the property by summation of the four category scores, by the fire composite score computation system, wherein data derived from the public databases and artificial intelligence as well as the input data received from the users or their self-inspections are transformed, by using customized algorithms, into an output comprising the fire composite score and the four category scores, and wherein the baseline fire composite score, or PhiChi, is transformed, by using the customized algorithms, into the complete fire composite score of the property, the 4score, thereby providing a comprehensive assessment of the wildfire risk of the property; and
h) an eighth computer program code for computing the final composite threat (FCT) score by the formula:
FCT score=(Ignition score+Susceptibilities score)*(Fuel score+Hazards score).
